(19) United States
(12) Patent Application Publication
(10) Pub. No.: US 2012/0270052 A1
(43) Pub. Date: Oct. 25, 2012

(54) COATING COMPOSITION FOR FOAM PARTICLES

(75) Inventors: Benjamin Nehls, Ludwigshafen (DE); Tatiana Ulanova, Ludwigshafen (DE); Sabine Fuchs, Mannheim (DE); Klaus Hahn, Kirchheim (DE); Bernhard Schmied, Frankenthal (DE)

(73) Assignee: BASF SE, Ludwigshafen (DE)

(21) Appl. No.: 13/512,149

(22) PCT Filed: Nov. 24, 2010
(86) PCT No.: PCT/EP2010/068081

§ 371 Date: May 25, 2012

(30) Foreign Application Priority Data
Nov. 27, 2009 (EP) 09177310.1

(51) Int. Cl. B32B 18/00; B32B 1/00; B29C 67/20

(52) U.S. Cl. 428/404; 264/126; 264/41

(57) ABSTRACT

The invention relates to a coating composition, foam particles coated therewith, processes for producing foam moldings, and their use.

The invention relates to a coating composition, foam particles coated therewith, processes for producing foam moldings, and their use.

Expanded polymer foams are usually obtained by sintering of foam particles, for example prefoamed expandable polystyrene particles (EPS) or expanded polypropylene particles (EPP), in closed molds by means of steam.

Flame-resistant polystyrene foams are generally provided with halogen-comprising flame retardants such as hexabromocyclododecane (HBCD). However, approval for use as insulating material in the building sector is limited to particular applications. The reason for this is, inter alia, the melting and dripping of the polymer matrix in the case of fire. In addition, the halogen-comprising flame retardants can not be used without restriction because of their toxicological properties.

WO 00/050500 A1 describes flame-resistant foams derived from prefoamed polystyrene particles which are mixed together with an aqueous sodium silicate solution and a latex of a high molecular weight vinyl acetate copolymer, poured into a mold and dried in air while shaking. This gives only a loose bed of polystyrene particles which are adhesively bonded to one another at few points and therefore have only unsatisfactory mechanical strengths.

WO 2005/105404 A1 describes an energy-saving process for producing foam moldings, in which the prefoamed foam particles are coated with a resin solution which has a softening temperature lower than that of the expandable polymer. The coated foam particles are subsequently fused in a mold with application of external pressure or by after-expansion of the foam particles by means of hot steam.

WO 2007/023089 A1 describes a process for producing foam moldings from prefoamed foam particles which have a polymer coating. As preferred polymer coating, use is made of a mixture of a water glass solution, water glass powder and a polymer dispersion. Hydraulic binders based on cement or metal salt hydrates, for example, aluminum hydroxide, can optionally be added to the polymer coating. A similar process is described by WO 2008/0437 A1, according to which the coated foam particles can be dried and subsequently processed to give a fire-resistant and heat-resistant foam molding.

WO 00/52104 A1 relates to a fire protection coating which forms an insulating layer in the case of fire and is based on substances which in the case of fire form a foam layer and carbon and comprises melamine polyphosphate as blowing agent. Information on the water resistance is not given.

WO 2008/043700 A1 relates to a process for producing coated foam particles having a water-insoluble polymer film. WO 2009/037116 relates to a coating composition for foam particles which comprises a clay mineral, an alkali metal silicate and a film-forming polymer.

Hydraulic binders such as cement set in aqueous slurry in the presence of carbon dioxide even at room temperature. Embrittlement of the foam board can occur as a result. In addition, the foam boards produced according to the prior art cited do not withstand temperatures above 800° C. in the case of fire and break down in the case of fire.

The known coating compositions are capable of improvement in respect of the simultaneous improvement of the flame/heat resistance and their water resistance when exposed to water or in the case of elevated humidity. Many known materials lose their original shape after a short time when exposed directly to water. Furthermore, if a conventional burning test is carried out, such materials frequently lose their structural integrity completely. All that remains is generally pulverulent mixtures which no longer meet the technical requirements.

WO 2004/022505 describes the production of an agglomerate-free, ceramic nanoparticle dispersion which makes it possible to obtain a homogeneous and uniform distribution of the nanoparticles in the substance systems to be produced or supplemented.

EP1043094 A1 describes an SiO₂ dispersion as binder. This document is concerned with processes for producing castings and embedding compositions.

DE 19534764 A1 describes thin, crack-free, preferably transparent and colorless SiO₂ sheets, a process for producing them by the sol-gel process and their use, e.g. as membranes, filters, constituents of laminates or support materials having incorporated functional additives.

U.S. Pat. No. 378,020 describes antihygroscopic coating of electrodes comprising colloidal SiO₂.

U.S. Pat. No. 4,045,593, EP-A-1537940, EP-A-468778 describes binders comprising colloidal silica for various fluxes.

It was an object of the present invention to provide coating compositions for foam particles, coated foam particles and foam moldings which have both a satisfactory flame/heat resistance and a satisfactory water resistance on prolonged exposure to water, in particular in durability tests in which a building material is exposed to elevated atmospheric humidities (close to 100%) and temperatures of about 65° C. and in which accelerated aging by storage of the samples under particular conditions such as elevated temperature, humidity or repeated freeze-thawing cycles is determined, in particular on the basis of the “European Recommendations for Sandwich Panels, Part 1, Design”, published on Oct. 23, 2000 by ECCS (European Convention for Constructional Steelwork).

The invention relates to a coating composition for coating foams, which comprises a ceramic material a), optionally an alkali metal silicate b) and optionally a film-forming polymer c), wherein nanosize SiO₂ particles d) are additionally comprised.

The ceramic materials to be used according to the invention ceramicize in the case of fire, i.e. not during production of the coating compositions and foam particles according to the invention. Preferred ceramic materials are clay minerals and calcium silicates, in particular the mineral wollastonite.

In a preferred embodiment, the composition comprises:
a) from 20 to 70 parts by weight of a ceramic material
b) optionally from 20 to 70 parts by weight of an alkali metal silicate
c) from 1 to 30 parts by weight of a film-forming polymer
d) from 1 to 60, in particular from 20 to 40 parts by weight of nanosize SiO₂ particles.

The coating composition is preferably used as an aqueous dispersion, with the water content including the water bound, for example, as water of crystallization preferably being in the range from 10 to 40% by weight, in particular from 15 to 30% by weight, based on the total aqueous dispersion.

In a particularly preferred embodiment, e) a hydrophobicizingly effective amount of a silicon-comprising compound, in particular a silicone, is additionally comprised, in particular from 0.2 to 5 parts by weight. In a particularly preferred embodiment, this is a silicone emulsion having silicone particles of differing size. Particularly good penetration into porous materials can be achieved in this way.

A preferred coating composition comprises

a) from 30 to 50 parts by weight of a ceramic material
b) from 30 to 50 parts by weight of an alkali metal silicate
c) from 5 to 20 parts by weight of a film-forming polymer
d) from 5 to 10 parts by weight of nanosize SiO₂ particles
e) from 0.5 to 3 parts by weight of a silicone
f) from 5 to 40 parts by weight of an infrared-absorbing pigment.

The amounts indicated above in each case relate to solids based on the solids of the coating composition. The components a) to e) or a) to f) preferably add up to 100% by weight.

The weight ratio of ceramic material to alkali metal silicate in the coating composition is preferably in the range from 1:2 to 2:1.

Suitable ceramic-forming clay minerals a) are, in particular, minerals comprising allophane Al₂[SiO₅]&O₃.nH₂O, kaolinite Al₄[(OH)₈|Si₄O₁₀], halloysite Al₄[(OH)₈|Si₄O₁₀].2H₂O, montmorillonite (smectite) (Al,Mg,Fe)₂[(OH₂|(Si,Al)₄O₁₀].Na_{0.33}(H₂O)₄, vermiculite Mg₂(Al,Fe,Mg)[(OH₂|(Si,Al)₄O₁₀].Mg_{0.35}(H₂O)₄ or mixtures thereof. Particular preference is given to using kaolin. A particularly suitable ceramic-forming calcium silicate is wollastonite.

As alkali metal silicate b), preference is given to using a water-soluble alkali metal silicate having the composition M₂O(SiO₂), where M=sodium or potassium and n=1 to 4 or mixtures thereof.

The coating composition generally comprises an uncrosslinked polymer which has one or more glass transition temperatures in the range from −60° to +100° C. as film-forming polymer c). The glass transition temperatures of the dried polymer film are preferably in the range from −30° C. to +80° C., particularly preferably in the range from −10° to +60° C. The glass transition temperature can be determined by means of differential scanning calorimetry (DSC, in accordance with ISO 11357-2, heating rate: 20 K/min). The molecular weight of the polymer film determined by gel permeation chromatography (GPC) is preferably below 400 000 g/mol.

The coating composition preferably comprises an emulsion polymer of ethylenically unsaturated monomers such as vinylaromatic monomers such as α-methylstyrene, p-methylstyrene, ethylstyrene, tert-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, piperylene or isoprene, (α,β-unsaturated carboxylic acids such as acrylic acid and methacrylic acid, esters thereof, in particular alkyl esters such as C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide, as film-forming polymer.

The polymers can, if appropriate, comprise from 1 to 5% by weight of comonomers such as (meth)acrylonitrile, (meth)acrylamide, ureido (meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The film-forming polymer is particularly preferably made up of one or more of the monomers styrene, butadiene, acrylic acid, methacrylic acid, C₁₋₄-alkyl acrylates, C₁₋₄-alkyl methacrylates, acrylamide, methacrylamide and methylolacrylamide.

Suitable polymers c) can be obtained, for example, by free-radical emulsion polymerization of ethylenically unsaturated monomers such as styrene, acrylates or methacrylates, as described in WO 00/50480.

The polymers c) are prepared in a manner known per se, for instance by emulsion, suspension or dispersion polymerization, preferably in the aqueous phase. It is also possible to prepare the polymer by solution or bulk polymerization, comminute it if appropriate and subsequently disperse the polymer particles in water in a customary manner. The polymerization is carried out using the initiators, emulsifiers or suspension auxiliaries, chain transfer agents or other auxiliaries customary for the respective polymerization process; the polymerization is carried out continuously or batchwise in customary reactors at the temperatures and pressures customary for the respective processing.

The nanosize SiO₂ particles d) to be used according to the invention are preferably aqueous, colloidal SiO₂ particle dispersions.

Preference is given to using an aqueous, colloidal SiO₂ particle dispersion which is stabilized by onium ions, in particular ammonium ions such as NH₄⁺, as counterion (as an alternative also by alkali metal and/or alkaline earth metal ions). The average particle diameter of the SiO₂ particles is in the range from 1 to 200 nm, preferably in the range from 10 to 50 nm. The specific surface area of the SiO₂ particles is generally in the range from 10 to 3000 m²/g, preferably in the range from 30 to 1000 m²/g. The solids content of commercial SiO₂ particle dispersion depends on the particle size and is generally in the range from 10 to 60% by weight, preferably in the range from 30 to 50% by weight. Aqueous, colloidal SiO₂ particle dispersions can be obtained by neutralization of dilute sodium silicates with acids, ion exchange, hydrolysis of silicon compounds, dispersion of pyrogenic silicate or gel precipitation.

The nanosize SiO₂ particles to be used according to the invention are known per se and can be present in various forms depending on the production process. Thus, it is possible to obtain suitable dispersions based on, for example, silica sol, silica gel, pyrogenic silicas, precipitated silicas or mixtures thereof. As is known, silica sols are colloidal solutions of amorphous silicon dioxide in water, and are also referred to as silicon dioxide sols or SiO₂ sols. In general, the silicon dioxide is present in the form of spherical particles which are hydroxylated on the surface.

The surface of the SiO₂ particles can have a charge which is balanced by appropriate counterions. Alkali-stabilized silica sols generally have a pH of from 7 to 11.5 and can be made alkaline by means of, for example, alkali metal hydroxides or nitrogen bases. The silica sols can also be present as colloidal solutions which are weakly acidic. Finally, the sols can, for example, have aluminum compounds on the surface.

In the case of precipitated silicas and pyrogenic silicas, the particles can be present either as primary particles or in the form of secondary particles (agglomerates). The average particle size reported here is, according to the invention, the average particle size determined by means of ultracentrifugation and includes the size of primary particles and any agglomerates thereof which may be present.

In a preferred embodiment, silicon dioxide dispersions in which the SiO₂ particles are present as discrete, uncrosslinked primary particles are used.

The silicone e) to be used according to the invention is preferably an aqueous silicone emulsion. In a particularly preferred embodiment, at least one of the following constituents is comprised in the silicone emulsion: silicic acid, diethoxyoctylsilyltrimethylsilylesther, hydroxy-terminated dimethylsiloxane with aminoethylaminopropylsilsesquioxane, triethoxyoctyl-silane.

To reduce the thermal conductivity, an infrared-absorbing pigment (IR absorber) such as carbon black, coke, aluminum, graphite or titanium dioxide is preferably used in amounts of from 5 to 40% by weight, in particular in amounts of from 10 to 30% by weight, based on the solids of the coating. The particle size of the IR-absorbing pigment is generally in the range from 0.1 to 100 μm, in particular in the range from 0.5 to 10 μm.

Preference is given to using carbon black having an average primary particle size in the range from 10 to 300 nm, in particular in the range from 30 to 200 nm. The BET surface area is preferably in the range from 10 to 120 m²/g.

As graphite, preference is given to using graphite having an average particle size in the range from 1 to 50 μm.

Furthermore, the coating composition can comprise flame retardants such as expandable graphite, borates, in particular zinc borates, in particular boron orthophosphate, or intumescent compositions which expand, swell or foam at high temperatures, in general above 80 to 100° C., to form an insulating and heat-resistant foam which protects the thermally insulating foam particles underneath from the effect of fire and heat.

When flame retardants are used in the polymer coating, it is also possible to achieve satisfactory fire protection using foam particles which do not comprise any flame retardants, in particular no halogenated flame retardants, or to make do with smaller amounts of flame retardants, since the flame retardant in the polymer coating is concentrated on the surface of the foam particles and forms a solid framework under the action of heat or fire.

The coating composition can comprise intumescent compositions which comprise chemically bound water or eliminate water at temperatures above 40° C., e.g. metal hydroxides, metal salt hydrates and metal oxide hydrates, as additional additives.

Suitable metal hydroxides are, in particular, those of groups 2 (alkaline earth metals) and 13 (boron group) of the Periodic Table. Preference is given to magnesium hydroxide, calcium hydroxide, aluminum hydroxide and borax. Particular preference is given to aluminum hydroxide.

Suitable metal salt hydrates are all metal salts into whose crystal structure water of crystallization is incorporated. Analogously, suitable metal oxide hydrates are all metal oxides which comprise water of crystallization incorporated in the crystal structure. Here, the number of molecules of water of crystallization per formula unit can be the maximum possible number or below, e.g. copper sulfate pentahydrate, trihydrate or monohydrate. In addition to the water of crystallization, the metal salt hydrates or metal oxide hydrates can also comprise water of constitution.

Preferred metal salt hydrates are the hydrates of metal halides (in particular chlorides), sulfates, carbonates, phosphates, nitrates or borates. Suitable compounds are, for example, magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrate and tin borate hydrates are particularly preferred.

Other possible metal salt hydrates are double salts or alums, for example those of the general formula: M^{I}M^{III}(SO₄)₂.12H₂O. M^{I} can be, for example, potassium, sodium, rubidium, cesium, ammonium, thallium or aluminum ions. It is possible for, for example, aluminum, gallium, indium, scandium, titanium, vanadium, chromium, manganese, iron, cobalt, rhodium or iridium to function as M^{III}.

Suitable metal oxide hydrates are, for example, aluminum oxide hydrate and preferably zinc oxide hydrate or boron trioxide hydrate.

Apart from the ceramic materials, further minerals, for example cements, aluminum oxides, vermiculite or perlite, can be additionally added to the coating. These can be introduced into the coating composition in the form of aqueous slurries or dispersions. Cements can also be applied to the foam particles by “dusting”. The water necessary for setting of the cement can then be introduced as steam during sintering.

The coating composition is used, in particular, for coating foam particles. The invention therefore further provides a process for producing coated foam particles by applying the coating composition of the invention, preferably in the form of an aqueous dispersion, to the foam particles and drying if appropriate.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have an average particle diameter in the range from 2 to 10 mm. The bulk density of the foam particles is generally from 5 to 100 kg/m³, preferably from 5 to 40 kg/m³ and in particular from 8 to 16 kg/m³, determined in accordance with DIN EN ISO 60.

The foam particles based on styrene polymers can be obtained by prefoaming EPS to the desired density by means of hot air or steam in a prefoamer. Final bulk densities below 10 g/l can be obtained by single or repeated prefoaming in a pressure prefoamer or continuous prefoamer.

To produce insulating boards having a high thermal insulation capability, particular preference is given to using prefoamed, expandable styrene polymers which comprise athermanous solids such as carbon black, aluminum, graphite or titanium dioxide, in particular graphite having an average particle diameter in the range from 1 to 50 μm, in amounts of from 0.1 to 10% by weight, in particular from 2 to 8% by weight, based on EPS, and are known, for example, from EP-B 981 574 and EP-B 981 575.

Furthermore, the foam particles can comprise from 3 to 60% by weight, preferably from 5 to 20% by weight, based on the prefoamed foam particles, of a filler. Possible fillers are organic and inorganic powders or fibrous materials and also mixtures thereof. As organic fillers, it is possible to use, for example, wood flour, starch, flax, hemp, ramie, jute, sisal, cotton, cellulose or aramid fibers. As inorganic fillers, it is possible to use, for example, carbonates, silicates, barites, glass spheres, zeolites or metal oxides. Preference is given to pulverulent inorganic materials such as talc, chalk, kaolin (Al₂(Si₂O₅)(OH)₄), aluminum hydroxide, magnesium hydroxide, aluminum nitride, aluminum silicate, barium sulfate, calcium carbonate, calcium sulfate, silica, quartz flour, Aerosil®, alumina or spherical or fibrous inorganic materials such as glass spheres, glass fibers or carbon fibers.

The average particle diameter, or in the case of fibrous fillers the length, should be in the region of the cell size or smaller. Preference is given to an average particle diameter in the range from 1 to 100 μm, preferably in the range from 2 to 50 μm.

Particular preference is given to inorganic fillers having a density in the range 1.0-4.0 g/cm³, in particular in the range 1.5-3.5 g/cm³. The brightness (DIN/ISO) is preferably 50-100%, in particular 60-98%.

The type and amount of fillers can influence the properties of the expandable thermoplastic polymers and the expanded polymer foam moldings obtainable therefrom. The use of bonding agents such as maleic anhydride-modified styrene copolymers, polymers comprising epoxide groups, organosilanes or styrene copolymers having isocyanate or acid groups enables the bonding of the filler to the polymer matrix and thus the mechanical properties of the expanded polymer foam moldings to be significantly improved.

In general, inorganic fillers reduce the combustibility. In particular, the addition of inorganic powders such as aluminum hydroxide, magnesium hydroxide or borax can further improve the burning behavior.

Such filler-comprising foam particles can, for example, be obtained by foaming filler-comprising, expandable thermoplastic pellets. In the case of high filler contents, the expandable pellets required for this purpose can be obtained by extrusion of thermoplastic melts comprising blowing agent and subsequent underwater pressure pelletization, as described, for example, in WO 2005/056653.

The polymer foam particles can additionally be provided with flame retardants. For this purpose, they can comprise, for example, from 1 to 6% by weight of an organic bromine compound such as hexabromocyclododecane (HBCD) and, if appropriate, additionally from 0.1 to 0.5% by weight of bicumyl or a peroxide in the interior of the foam particles or the coating. However, preference is given to using no halogen-comprising flame retardants.

The coating composition of the invention is preferably applied in the form of an aqueous polymer dispersion to the foam particles.

The water glass powder comprised in the coating mixture leads to better or more rapid film formation and thus more rapid curing of the foam molding. If appropriate, hydraulic binders based on cement, lime cement or gypsum plaster can additionally be added in amounts at which no appreciable embrittlement of the foam occurs.

To coat the foam particles, it is possible to use customary methods such as spraying, dipping or wetting of the foam particles with an aqueous coating composition in customary mixers, spraying apparatuses, dipping apparatuses or drum apparatuses.

Furthermore, the foam particles which have been coated according to the invention can additionally be coated with amphiphilic or hydrophobic organic compounds. The coating with hydrophobicizing agents is advantageously carried out before application of the aqueous coating composition of the invention. Among hydrophobic organic compounds, particular mention may be made of C₁₀-C₃₀-paraffin waxes, reaction products of N-methylolamine and a fatty acid derivative, reaction products of a C₉-C₁₁-oxo alcohol with ethylene oxide, propylene oxide or butylene oxide or polyfluoroalkyl (meth)acrylates or mixtures thereof, which can preferably be used in the form of aqueous emulsions.

Preferred hydrophobicizing agents are paraffin waxes which have from 10 to 30 carbon atoms in the carbon chain and preferably have a melting point in the range from 10 to 70° C., in particular from 25 to 60° C. Such paraffin waxes are comprised, for example, in the commercial BASF products RAMASIT KGT, PERSISTOL E and PERSISTOL HP and also in AVERSIN HY-N from Henkel and CEROL ZN from Sandoz.

Another class of suitable hydrophobicizing agents comprises resin-like reaction products of an N-methylolamine with a fatty acid derivative, e.g. a fatty acid amide, amine or alcohol, as described, for example, in U.S. Pat. No. 2,927,090 or GB-A 475 170. Their melting point is generally from 50 to 90° C. Such resins are comprised, for example, in the commercial BASF product PERSISTOL HP.

Finally, polyfluoroalkyl (meth)acrylates, for example polyperfluorooctyl acrylate, are also suitable. The latter substance is comprised in the commercial BASF product PERSISTOL O and in OLEOPHOBOL C from Pfersee.

Further possible coating agents are antistatics such as Emulgator K30 (mixture of secondary sodium alkanesulfonates) or glyceryl stearates such as glyceryl monostearate GMS or glyceryl tristearate. However, the coating agents customary for coating expandable polystyrene, in particular stearates, can be used in a reduced amount or dispensed with entirely in the process of the invention without the product quality being adversely affected.

To produce foam moldings, the foam particles provided with the coating according to the invention can be sintered in a mold. Here, the coated foam particles can be used in the still-moist state or after drying.

The drying of the coating composition applied to the foam particles can, for example, be carried out in a fluidized bed, paddle dryer or by passing air or nitrogen through a loose bed. In general, a drying time of from 5 minutes to 24 hours, preferably from 30 to 180 minutes, at a temperature in the range from 0 to 80° C., preferably in the range from 30 to 60° C., is sufficient to form the water-insoluble polymer film.

The water content of the coated foam particles after drying is preferably in the range from 1 to 40% by weight, particularly preferably in the range from 2 to 30% by weight, very particularly preferably in the range from 5 to 15% by weight. It can be determined, for example, by Karl-Fischer titration of the coated foam particles. The weight ratio of foam particle/coating mixture after drying is preferably from 2:1 to 1:10, particularly preferably from 1:1 to 1:5.

The foam particles which have been dried according to the invention can be sintered by means of hot air or steam in conventional molds to produce foam moldings.

In the sintering or conglutination of the foam particles, the pressure can be generated, for example, by reducing the volume of the mold by means of a movable punch. In general, a pressure in the range from 0.5 to 30 kg/cm² is set here. The mixture of coated foam particles is for this purpose introduced into the open mold. After the mold has been closed, the foam particles are pressed by means of the punch, with the air between the foam particles escaping and the volume of the interstices being reduced. The foam particles are joined via the coating to form foam moldings.

Preference is given to compaction by about 10-90%, preferably 60-30%, in particular 50-30%, of the initial volume. In the case of a mold having a cross section of about 1 m², a pressure of from 1 to 5 bar is generally sufficient for this.

The mold is configured according to the desired geometry of the foam moldings. The degree of fill depends, inter alia, on the desired thickness of the future molding. In the case of foam boards, a simple box-like mold can be used. In the case of more complicated geometries, in particular, it can be necessary to densify the bed of the particles introduced into the mold and in this way eliminate undesirable voids. Densification can be effected, for example, by shaking of the mold, tumbling motions or other suitable measures.

To accelerate setting, hot air or steam can be injected into the mold or the mold can be heated. However, any heat transfer media such as oil or steam can be used for heating the mold. The hot air or the mold is for this purpose advantageously heated to a temperature in the range from 20 to 120° C., preferably from 30 to 90° C.

As an alternative or in addition, sintering can be carried out continuously or batchwise under irradiation with microwave energy. Microwaves in the frequency range from 0.85 to 100 GHz, preferably from 0.9 to 10 GHz, and irradiation times in the range from 0.1 to 15 minutes are generally used here. Foam boards having a thickness of more than 5 cm can also be produced in this way.

When hot air or steam having a temperature in the range from 80 to 150° C. or irradiation with microwave energy is used, a gauge pressure of from 0.1 to 1.5 bar is usually established, so that the process can also be carried out without external pressure and without a reduction in the volume of the mold. The internal pressure generated by relatively high temperatures allows the foam particles to expand slightly more and they can also become fused by softening of the foam particles themselves in addition to conglutination via the polymer coating. This results in disappearance of the interstices between the foam particles. To accelerate setting, the mold can be additionally heated by means of a heat transfer medium as described above. When irradiation with microwaves is employed, heating of the inorganic coating constituents generally occurs and these then crosslink or condense more rapidly as a result.

Double-belt plants as are used for the production of polyurethane foams are also suitable for the continuous production of foam moldings. For example, the prefoamed and coated foam particles can be applied continuously to the lower of two metal belts, which may optionally have perforations, and be processed with or without compression by means of the converging metal belts to form continuous foam boards. In one process embodiment, the volume between the two belts is increasingly reduced, as a result of which the product is compressed between the belts and the interstices between the foam particles disappear. After a curing zone, a continuous board is obtained. In another embodiment, the volume between the belts can be kept constant and the foam particles can go through a zone with hot air or microwave irradiation in which they foam further. Here too, the interstices disappear and a continuous board is obtained. It is also possible to combine the two continuous process embodiments. The thickness, length and width of the foam boards can vary within wide limits and is limited by the size and closure force of the tool. The thickness of the foam boards is usually from 1 to 500 mm, preferably from 10 to 300 mm. Further preferred sizes and orders of magnitude are from 10 to 200 mm, preferably from 20 to 110 mm, particularly preferably from 25 to 95 mm.

The thickness of the foam moldings in accordance with DIN 53420 is generally from 10 to 150 kg/m³, preferably from 20 to 90 kg/m³. The process makes it possible to obtain foam moldings having a uniform thickness over the entire cross section. The density of the outer layers corresponds approximately to the density of the interior regions of the foam moldings.

It is also possible to use comminuted foam particles from recycled foam moldings in the process. To produce the foam moldings according to the invention, the comminuted recycled foam material can be used in a proportion of 100% or, for example, in proportions of from 2 to 90% by weight, in particular from 5 to 25% by weight, together with fresh material without significantly impairing the strength and the mechanical properties.

It is also possible to add further additives which preferably make very little, if any, contribution to the combustibility and/or materials which in the unburnt state have a positive effect on the mechanical or thermal properties, for example vermiculites, to the coating in order to modify the mechanical and hydraulic properties.

A preferred process comprises the steps:
i) prefoaming of expandable styrene polymers to form foam particles,
ii) application of the coating composition of the invention in the form of an aqueous dispersion to the foam particles,
iii) drying of the dispersion on the foam particles to form a water-insoluble polymer film
iv) introduction of the foam particles coated with the polymer film into a mold and sintering.

A particularly preferred process comprises pressing of the foam particles while still moist with water according to the following process:
i) prefoaming of expandable styrene polymers to form foam particles,
ii) application of the coating composition of the invention in the form of an aqueous dispersion to the foam particles,
iii) introduction of the foam particles which have been coated with the coating composition and are still moist with water into a mold, pressing and curing by action of heat and/or microwaves.

The coating compositions of the invention are suitable for producing simple or complex foam moldings such as boards, blocks, tubes, rods, profiles, etc. Preference is given to producing boards or blocks which can subsequently be sawn or cut into boards. Boards or blocks can be used, for example, in building and construction for the insulation of exterior walls. They are particularly preferably used as core layer for the production of sandwich elements, for example structural insulation panels (SIPs) which are used for the construction of coolstores or warehouses.

### EXAMPLES

### Test Methods

To test the quality of the samples, a series of tests were carried out:

### Test A

Firstly, the decrease in volume in the case of fire (test A) was determined after the proper storage time. For this purpose, a cube having an edge length of 5 cm was sintered at 1030° C. or 800° C. in a muffle furnace for 15 minutes. The volume of the cube was subsequently determined again and subtracted from the initial volume.

### Test B

Leaching of the cube was also determined (test B). For this purpose, a cube having an edge length of 5 cm was completely immersed in water having a temperature of 50° C. and completely wetted with water for 24 hours. The cube was subsequently dried and weighed again and the proportion of coating washed out was thus determined. The water in the container was evaporated and the residue was weighed so that a more precise value was determined.

### Test C

The cube was subsequently dried completely again and subjected to a burning test as described for test A. This gave the burning loss after exposure to water (test C).

Production of coating mixtures and the polystyrene foam particles.

Commercial polystyrene foam particles (10 g/l, Neopor® 2300) were homogeneously coated with the coating indicated in table 2 in the weight ratio EPS:mixture specified there. The coated particles were then introduced into an aluminum mold (20×20 cm) and pressed to 50% of the original volume. The testing of the specimens obtained was carried out as described under “Test methods”.

In the examples below, the following substances are used:

TABLE 1

| Substance | Chemical composition | Trade name/remarks |
|---|---|---|
| a1 | Clay minerals | |
| a11 | Silicate/CaSiO₃ | Wollastonite |
| b1 | Potassium silicate/water glass | Protil ® N/Betulin K42 |
| c1 | Styrene acrylate | Acronal ® S790 |
| d1 | Silica sol, nanosize | Levasil ® 50/50 |

The specimens indicated in table 2 are produced therefrom, with the figures under the substances a1) to d1) being the parts by weight used:

TABLE 2

| Specimen | a1 | a11 | b1 | c1 | d1 | Density | EPS/mix |
|---|---|---|---|---|---|---|---|
| 1 | 100 | | 100 | 22 | 0 | 75 | 4.0 |
| 2 | 145 | | | 30 | 150 | 82 | 4.2 |
| 3 | | 120 | 80 | | 160 | 84 | 4.2 |
| 4 | | 120 | 60 | 40 | 160 | 76 | 4.0 |
| 5 | | 120 | 60 | 20 | 160 | 96 | 4.6 |
| 6 | | 120 | 60 | 20 | 160 | 65 | 3.6 |

The column EPS/mix reports the weight ratio of the inorganic constituents to the foam.

Table 3 below gives the results of the testing of the specimens indicated in table 2:

TABLE 3

| Specimen | | | |
|---|---|---|---|
| (comparison) | Test C | Test A | Test B |
| 1 | 20 | 8 | not measurable since |
| | | | specimen has |
| | | | disintegrated |
| 2 | 2 | 16 | 17 |
| 3 | 8 | 7 | 3 |
| 4 | 8 | 2 | 4 |
| 5 | 3 | 3 | 0.6 |
| 6 | 5 | 3 | 7 |

It can be seen from table 3 that the specimens 2 to 6 according to the invention, which unlike the comparative specimen 1 comprise a silica sol, are significantly improved both in respect of washing-out and the burning behavior.

1-15. (canceled)

16. A foam particle of expanded polyolefin particles or optionally prefoamed particles of expandable styrene polymers having a coating comprising a ceramic material a), optionally an alkali metal silicate b) wherein a film-forming polymer c), and nanosize SiO₂ particles d) are additionally comprised in the coating.

17. The foam particle according to claim 16, wherein
a) from 20 to 70 parts by weight of a ceramic material,
b) optionally from 20 to 70 parts by weight of an alkali metal silicate,
c) from 1 to 30 parts by weight of a film-forming polymer
d) from 1 to 60 parts by weight of nanosize SiO₂ particles d) are comprised in the coating.

18. The foam particle according to claim 16, wherein
a) from 20 to 70 parts by weight of a clay mineral or wollastonite,
b) optionally from 20 to 70 parts by weight of an alkali metal silicate,
c) from 1 to 30 parts by weight of a film-forming polymer
d) from 1 to 60 parts by weight of nanosize SiO₂ particles d) are comprised in the coating.

19. The foam particle according to claim 16, wherein the nanosize SiO₂ particles d) have a BET surface area of from 10 to 3000 m2/g.

20. The foam particle according to claim 16, wherein the weight ratio of ceramic material a) to alkali metal silicate b) is in the range from 1:2 to 2:1.

21. The foam particle according to claim 16, which comprises wollastonite or allophane Al₂[SiO₅]&O₃×nH₂O, kaolinite Al₄[(OH)₈/Si₄O₁₀], halloysite Al₄[(OH)₈/Si₄O₁₀]×2H₂O, montmorillonite (smectite) (Al,Mg,Fe)₂[(OH₂/(Si,Al)₄O₁₀]×Na_{0.33}(H₂O)₄, vermiculite Mg₂(Al,Fe,Mg)[(OH₂/(Si,Al)₄O₁₀]×Mg_{0.35}(H₂O)4 or mixtures thereof as ceramic material.

22. The foam particle according to claim 16, which comprises a water-soluble alkali metal silicate having the composition M₂O(SiO₂)ₙ where M=sodium or potassium and n=1 to 4 or mixtures thereof as alkali metal silicate b).

23. The foam particle according to claim 16, which comprises an emulsion polymer of ethylenically unsaturated monomers which has a glass transition temperature in the range from −30° to +80° C. determined by means of differential scanning calorimetry DSC, according to ISO 11357-2, heating rate: 20 K/min., as film-forming polymer.

24. A process for producing foam moldings, which comprises sintering the foam particle according to claim 16 in a mold.

25. The process according to claim 24 which comprises the following steps:
(i) prefoaming of expandable styrene polymers to form foam particles,
(ii) applying the coating composition comprising a ceramic material a) optionally an alkali metal silicate b), a film-forming polymer c) and nanosize SiO₂ particles d), in the form of an aqueous dispersion to the foam particles,
(iii) drying of the dispersion on the foam particles to form a water-insoluble polymer film and
(iv) introducing the foam particles coated with the polymer film into a mold and sintering.

26. The process according to claim 24 which comprises the steps:
i) prefoaming expandable styrene polymers to form foam particles,
ii) applying the coating composition comprising a ceramic material a), optionally an alkali metal silicate b), a film-forming polymer c) and nanosize SiO₂ d) in the form of an aqueous dispersion to the foam particles,
iii) introducing the foam particles which have been coated with the coating composition and are still moist with water into a mold, pressing and curing by action of heat and/or microwaves.

27. A process for producing boards, blocks, tubes, rods, profiles and as core layer for producing sandwich elements which comprises utilizing the foam molding produced according to claim 24.
